(19) United States
(12) Patent Application Publication
(10) Pub. No.: US 2010/0262929 A1
(43) Pub. Date: Oct. 14, 2010

(54) Method and system for dynamic configuration of remote control inputs

(75) Inventor: John Avery, Newman, GA (US)

Correspondence Address: PANASONIC AUTOMOTIVE SYSTEM;COMPANY OF AMERICA, 776 HWY 74 SOUTH, PEACHTREE CITY, GA, 30269, US

(73) Assignee: Panasonic Automotive Systems Company of America, Division of Panasonic Corporation of North America, Peachtree City, GA (US)

(21) Appl. No.: 12/386,345

(22) Filed: Apr. 8, 2009

(51) Int. Cl. G06F 3/048

(52) U.S. Cl. 715/771; 345/173

(57) ABSTRACT

A control arrangement for a vehicle includes an infotainment console having a first user interface. A wireless communication device is communicatively coupled to the infotainment console and relays wireless signals between the infotainment console and a portable computing device. The infotainment console interrogates the portable computing device regarding a configuration of a second user interface belonging to the portable computing device; receives responses to the interrogation from the portable computing device; and reconfigures the first user interface to substantially replicate a layout and functions of the second user interface.

### BACKGROUND OF THE INVENTION

1. Field of the Invention

The present invention relates to portable computing devices and, more particularly, to apparatuses and methods for controlling portable computing devices.

2. Description of the Related Art

Many portable devices today contain very powerful processors and large amounts of memory. These devices include cell phones, music players, network appliances, and personal navigation devices. These devices contain many valuable and complex applications including games, rich media, navigation, information management, etc. However, the significant computing power available in these devices is still constrained by a small display and small speakers required by the mobile environment.

Many vehicles include entertainment systems having components such as radios, DVD (digital video disc) players, CD (compact disc) players, cameras and navigational systems to provide entertainment and information to the driver. These components are controlled using a user interface in the form of a control panel typically having many buttons, knobs, screens and other devices. Home entertainment systems, such as home theaters, also include well developed user interfaces.

Current systems require the remote device to be aware of the interfaces available on the portable device and to attempt to emulate them. This can be seen most clearly on standard remote desktop systems where the remote mouse and keyboard inputs are emulated on the server device.

What is neither described nor suggested in the prior art is a way to use the more sophisticated and user-friendly user interface of a remote peripheral device such as an automobile or home theater to control a portable computing device such as a cell phone. Even for portable computing devices that do provide for a connection for remote display, what is missing is a common method for remoting the control interface for the portable device. That is, what is missing is a common way to control the portable device from an external remote control or touch screen. The very wide variety of control interfaces on portable devices makes providing such external control particularly difficult. These input controls on portable devices range from touch screens to full keyboards to numeric keypads, wheels and other haptic interfaces. In fact, most portable devices have a mix of such input controls.

### SUMMARY

The present invention provides an apparatus and method for enabling a remote system such as a vehicle infotainment system or home theater to configure its user interface such that the interface may be used to control a portable computing device such as a cell phone, web pad, media player, navigation device, etc. Thus, the display, audio and input controls of the portable device may be exported to a remote screen, speakers and input devices when a larger, more robust system of a remote peripheral system is available, such as that of a home or automobile.

In one aspect, the present invention provides a portable computing device operable by a peripheral device disposed at a location that is remote from the portable computing device. The peripheral device may include a control panel and display screen that are more user-friendly and/or that provide more features than does the user interface of the portable computing device. A wireless communication device is adapted to send and receive, or relay, wireless signals between the remote peripheral device and the portable computing device such that an application program interface of the portable computing device is accessible by the remote peripheral device via the wireless communication device.

In one embodiment, the present invention comprises a control arrangement for a vehicle including an infotainment console having a first user interface. A wireless communication device is communicatively coupled to the infotainment console and relays wireless signals between the infotainment console and a portable computing device. The infotainment console interrogates the portable computing device regarding a configuration of a second user interface belonging to the portable computing device; receives responses to the interrogation from the portable computing device; and reconfigures the first user interface to substantially replicate a layout and functions of the second user interface.

In another embodiment, the present invention comprises a control method including providing a peripheral device having a first user interface. A portable computing device having a second user interface is provided. The portable computing device is communicatively coupled to the peripheral device. The peripheral device is used to interrogate the portable computing device regarding a configuration of the second user interface. The peripheral device is used to receive responses to the interrogation from the portable computing device. The first user interface is reconfigured to substantially replicate a layout and functions of the second user interface.

In yet another embodiment, the present invention comprises a control arrangement including an infotainment console having a first user interface with a touch screen display. A communication device is communicatively coupled to the infotainment console and relays signals between the infotainment console and a portable computing device. The infotainment console interrogates the portable computing device regarding a second user interface belonging to the portable computing device; receives responses to the interrogation from the portable computing device; and reconfigures the first user interface to substantially replicate a layout and functions of the second user interface. The reconfiguring includes replicating pushbuttons of the second user interface on the touch screen display.

An advantage of the present invention is that it makes it possible for complex peripherals such as automobiles and home theaters to be used as remote control devices for portable computing devices such as cell phones, web pads, media players, navigation devices, etc. Thus, a user may use a larger and easier to use user interface of a remote peripheral device to control the operation of a portable computing device. Rich media content or applications may be enjoyed on a larger screen and with better input controls than are available directly on the portable computing device.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a diagram of a portable computing device control arrangement in accordance with one embodiment of the present invention;

FIG. 2 is a diagram of one embodiment of a user interface system of the vehicle of FIG. 1;

FIG. 3 is a front view of one embodiment of a user interface of the portable computing device of FIG. 1; and

FIG. 4 is a diagram of the user interface system of FIG. 1 while mimicking the portable computing device user interface of FIG. 3.

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

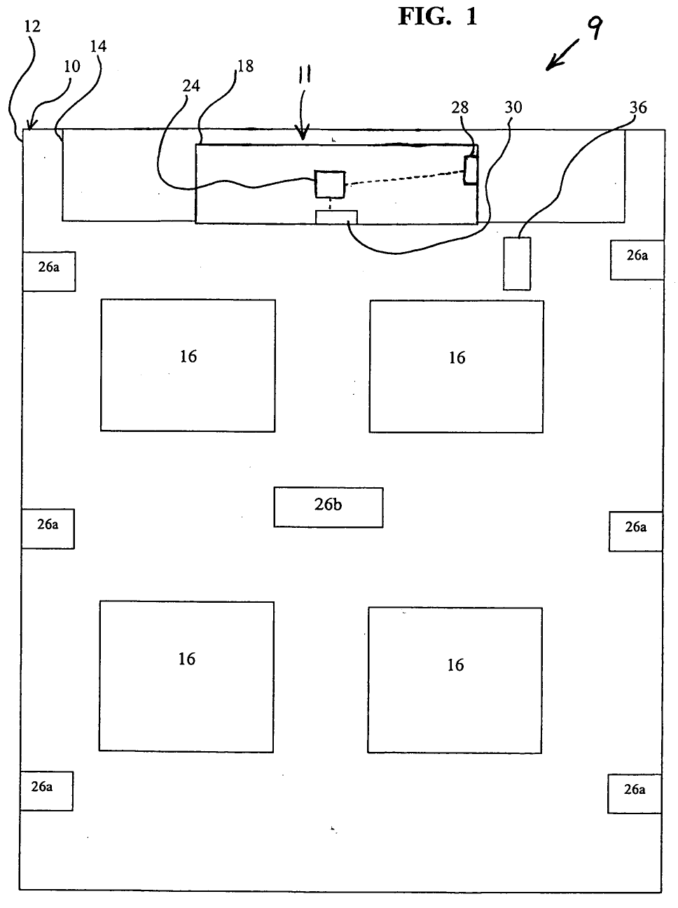

Referring to FIG. 1, a portable computing device control arrangement 9 including a portable computing device 36 disposed within a vehicle 10 is illustrated. Vehicle 10 may be equipped with an infotainment system 11 and generally includes vehicle body 12 defining an interior space. Vehicle 10 includes dashboard 14 disposed within the interior space and extending along the front of vehicle body 12, and seats 16 disposed within the interior space. Infotainment system 11 generally includes infotainment console 18, output units 26a-26b communicatively coupled to infotainment console 18 and wireless communication device 28 communicatively coupled to infotainment console 18.

Infotainment console 18 also includes a user interface 30, which is communicatively coupled to an application program interface 24. Application program interface 24 may be in the form of, and include, any application program interface, processor, source code, object code, software, implementations or other programs useful in operating user interface 30 as well as infotainment applications (not shown). User interface 30 is adapted to receive commands from the user and allows the user to control the operation of application program interface 24 and, ultimately, the infotainment applications. User interface 30 may be in any form suitable for allowing the user to operate application program interface 24. For instance, user interface 30 may include buttons, dials, scroll wheels, a keyboard, a touch pad, a voice recognition device, a display screen, a mouse and/or other user interface devices.

Referring still to FIG. 1, output units 26a-26b are communicatively coupled to infotainment console 18 and are adapted to receive the output signals generated by infotainment console 18. Output units 26a-26b are configured to broadcast an output in the form that the user may recognize and enjoy. Output units 26a-26b may be any device capable of generating such an output. For instance, output units 26a-26b may include audio speakers 26a positioned throughout the interior space defined by vehicle body 12 and adapted to broadcast audio/sound through the interior space. Alternatively, or additionally, output units 26a-26b may include visual display unit 26b, such as a monitor or other video display unit, capable of displaying visual images.

Infotainment system 11 also includes wireless communication device 28, which is communicatively coupled and connected to infotainment console 18. Wireless communication device 28 is adapted to transmit information to a portable computing device 36 and receive information from portable computing device 36. Wireless communication device 28 may be any communication device capable of wirelessly communicating with a portable computing device. For instance, wireless communication device 28 may be in the form of a short range communications device such as a radio frequency communications module, a Wi-Fi communications module, IEEE 802.11 communications module, or a Bluetooth communications module. Portable computing device 36 may be in the form of a cellular phone, personal data assistance (PDA), iPhone, Blackberry®, laptop computer or other wireless communications device.

Portable computing device 36 is described herein as being primarily a wireless device. However, it is within the scope of the invention for infotainment console 18 to be selectively, removably and/or temporarily hardwired to portable computing device 36, and for communication to occur therebetween via the hardwired connection.

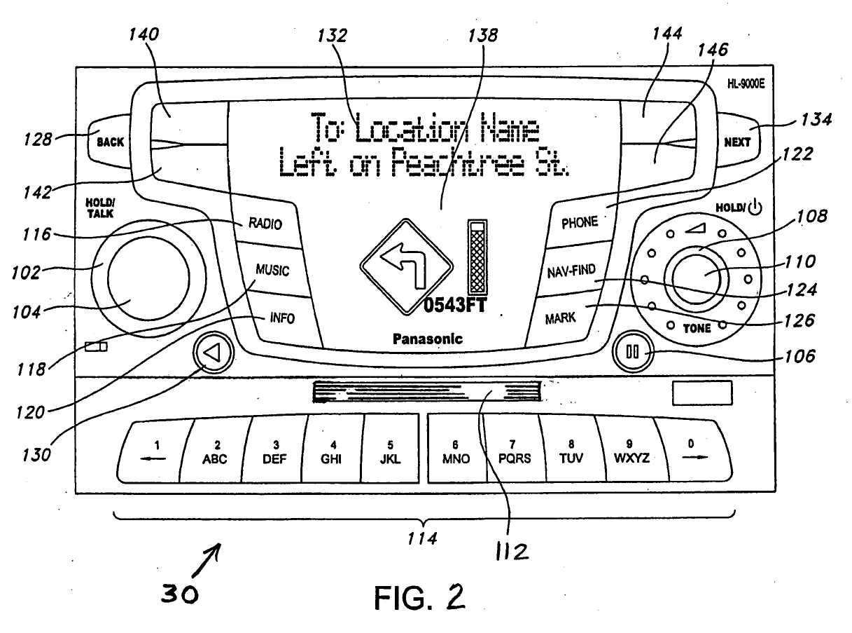

Referring now to FIG. 2, one specific embodiment of user interface 30 of infotainment console 18 is shown in detail. User interface 30 includes a display screen and a number of controls. In one embodiment, the display includes a first display area 132 and a second display area 138. First display area 132 provides text information. The text information includes labels for soft controls, lists, list modifiers, descriptive text, and prompts. First display area 132 can use different colors to denote the different types of text being displayed. A variety of fonts and sizes can also be used to assist the user in distinguishing between different types of text information.

Second display area 138 provides graphical information. The graphical information includes mode or feature icons, informative logos and navigational icons. In some instances the graphical information provides similar information as that provided by the text in the first display area. In other instances the graphical information provides additional information. The system can allow for simple transitions such as fades and wipes when switching between images. The system can also display animated images. Exemplary image formats include, but are not limited to, GIF, TIFF, MPEG and JPEG.

A variety of display arrangements are possible. In one embodiment, the first display area corresponds to one type of display, such as a Vacuum Fluorescent Display (“VFD”), and the second display area corresponds to a second type of display, such as a Liquid Crystal Display (“LCD”). In another embodiment, a single display is used that provides a first display area and a second display area. In yet another embodiment, the second display area is positioned on the instrument panel. In some embodiments, only a single display area is used. If so, then the information displayed on the single display can be text information or a combination of text and graphical information. If only a single display area is used, then the display area may display the information described herein as associated with the first display area, with the second display area, or with either or both of the two display areas.

The controls are strategically placed near the display, as shown in FIG. 2. By the controls being disposed near the display, user-system interaction is more efficient because a user can select a control near the data display to scroll through data, select a specific data item, or change functions. The user need not divert his attention from the data because the controls can be in the user's field of view. Thus, a user can comprehend displayed data and make corresponding data selection at a single glance. The reduced time focused on the data display enables the user to devote more time to operating the vehicle, thereby reducing the chance of having an accident.

The terms control, button and key are used interchangeably herein to refer to any type of input device including, but not limited to, a dial, button, key or pressure sensitive screen. The terms soft control, soft button and soft key refer to a control with a function that varies based on the active mode or feature. Typically, a label, symbol, icon or other indicator indicates the current function corresponding to a soft control. FIG. 2 illustrates four soft controls 140, 142, 144, 146 located proximate to the first display area. The current function of a soft control is indicated by a label, symbol or icon shown on the display adjacent to the soft control. If the soft control is not functional in a particular mode, then the display is blank next to the soft control. FIG. 2 illustrates the use of a portion of the first display area for soft control labels. In FIG. 2, the soft controls are used for scrolling and arrows representing the scroll direction are displayed next to the soft controls. Other embodiments may use a different number or placement of the soft controls or a different manner of providing an indication of the control's function.

FIG. 2 also illustrates a number of mode controls 116, 118, 120, 122, 124, 126, a self-centering jog dial 102, a confirmation control 104, a rotary encoder 108, 110, a number of preset controls 114, a back control 128, a next control 134, a pause control 106, a scroll wheel control 112 and a recall control 130. Other embodiments may include additional or fewer controls and the controls may be arranged differently. A control can provide a consistent function in all modes and features or can provide a variable function depending upon the active mode and feature. Moreover, a control can provide a different function depending upon how it is activated. Pushing and holding a control may provide a different function than simply pushing and releasing the control. Similarly, turning a control hard or turning and holding a control may provide a different function than simply turning and releasing the control.

The exemplary mode controls shown in FIG. 2 correspond to a broadcast content mode 116, a stored content mode 118, a requested content mode 120, a portable computing device communication mode 122, a navigation mode 124 and a destination mark mode 126. The broadcast content mode provides access to broadcast content, such as radio. The stored content mode provides access to content stored in memory or on disk, such as a music CD. The requested content mode provides access to content that can be obtained via a query, such as content available on the Internet. The communication mode provides communication with portable computing device 36, such as a cellular telephone. The navigation mode provides route guidance and navigation services. The mark mode allows the user to mark locations so that the marked locations can be used with the navigation services.

There may be multiple features within a mode. For example, the broadcast content mode includes a number of features, such as AM radio, FM radio, and satellite radio. The stored content mode supports a number of formats, such as CD, DVD and MP3. The communication mode enables user interface 30 to be used by the user in interfacing with portable computing device 36. User interface 30 may mimic the user interface of device 36 as well as provide additional controls or features for interfacing with device 36. The navigation mode includes a number of features, such as navigation by address, navigation by phone number, navigation by name and navigation by place.

If there are multiple features within a mode, then repeatedly activating the mode control cycles through the features. Pushing and holding a mode control initiates the setup option for the corresponding mode. The setup option allows the user to establish settings for the mode, as well as some system settings.

Modes may be of different types. In one embodiment, the mode types include long duration and short duration. Long duration modes are those that the user typically activates for a relatively long period of time. Short duration modes are those that the user typically activates for a relatively short period of time. Broadcast content, stored content, and requested content are long duration modes. Communication, navigation and mark modes are short duration modes. In one embodiment, if the user changes modes from a long duration mode to a short duration mode, then the system automatically returns to the previously selected long duration mode once the activity associated with the short duration mode is completed. For example, if the user switches from the stored content mode to the communication mode to place a telephone call, then once the call is completed, the system automatically returns to the stored content mode and begins playing the stored content from the point it was playing when the communications mode was activated.

Additional or fewer modes and features may be provided in other embodiments. For example, modes for front seat functions and rear seat functions or for vehicle control functions may be provided.

In one embodiment, the controls are organized by function. As shown in FIG. 2, the soft controls are arranged near the first display area and the mode controls are arranged near the second display area. Moreover, the long duration mode controls are located on the one side of the second display area and the short duration mode controls are located on the other side of the second display area. Although FIG. 2 illustrates that the long duration mode controls are located on the left-hand side and the short duration controls are located on the right-hand side, the controls can be located on either side.

The jog dial or select control 102 can be used to navigate within feature prompts. The select control can be used to scroll through lists of data, such as street names or phone numbers, or to adjust a radio station frequency. In one embodiment, the select control is a self-centering (spring loaded) dial with multiple contact locations. The contacts allow the system to determine the speed and acceleration at which the dial is activated. This allows the jog dial to perform different functions depending on the amount it is turned and whether it is immediately released or held for a set duration.

In one embodiment, the select control surrounds the confirmation control 104. The confirmation control can be used to confirm a user's selection or entry. The function associated with the confirmation control can change depending on the active mode and feature. For some modes or features, the confirmation control duplicates the functions of another control, such as the next control 134 or soft control 142. Depressing and holding the confirmation control activates a speech recognition function that allows the user to use verbal commands to interface with the system.

The next 134 and back 128 controls can be used to navigate through mode or feature prompts. If the user has keyed-in text within a prompt, pressing the back control removes the last entered character. If a prompt has no keyed-in in text, the back control returns to the last prompt. The next and back controls can also be used in the stored content mode to switch between tracks, such as tracks of a CD, in the broadcast content mode to switch between radio stations, or in the communication mode to switch between types of lists, modes, or features associated with portable computing device 36.

The preset controls 114 include controls for storing and accessing preset information, as well as entering alphanumeric information. Depending upon the mode or feature, the preset controls default to letter entry or number entry.

Rotary encoder 108 is used to control the volume, audio controls and power. In one embodiment, the rotary encoder is free spinning with no stops and a single step push button 110. Turning the encoder one way adjusts the output volume up and turning the encoder the other way adjusts the output volume down. The system can support multiple audio output sources having independent volume settings, as well as multiple audio output sources controlled by a universal volume setting. For example, the broadcast content and stored content modes can use a universal volume setting, whereas the Text To Speech (“TTS”) function, telephone ringer and telephone voice in communication mode, and audible tone features can have independent volume settings.

In one embodiment, pressing and releasing the encoder enters the audio control menu. Once in the audio control menu, repeatedly depressing the encoder cycles through the audio control menu options. Exemplary options include: balance, fade, treble, mid range and bass. Once in an audio control menu option, turning the encoder adjusts the value for the selected option. The display can provide a visual representation of the current settings to assist the user in making adjustments. The system can be powered on or off by depressing the encoder.

An optional pause control 106 can be used to pause certain audio outputs of the system, such as the output of the broadcast content, stored content, requested content or communication modes. If the content is stored, the system can terminate the playback and mark the termination location. When the pause control is pressed a second time, the system can return to the marked location and reactivate the playback. In the broadcast content mode, the system can use an internal digital storage medium to cache the data until the pause control is pressed again.

In some instances multiple modes are active concurrently. In these situations, the recall control 130 is used to switch between the modes. For example, if the navigation mode and the communication mode are both active, then the user can toggle between the two modes using the recall control instead of using the mode controls.

Feedback tones confirm the user's activation of the controls. For example, a tone can be provided whenever the user activates and releases a control and a different tone can be provided whenever the user activates and holds the control. The tone can vary based upon the active mode or feature.

The interface can present information to the user in multiple formats. For example, text describing a location may be displayed in the first display area, a logo associated with the location may be displayed in the second display area, and audio describing the location may be output using the TTS function. Alternatively, in the communication mode, a name and phone number of a person currently being conversed with may be displayed in the first display area, a picture or photograph associated with the person may be displayed in the second display area, and the person's voice may be output in real time using speakers 26a.

Operation of control arrangement 9 in accordance with one embodiment of the present invention will now be described. Control arrangement 9 enables a user to operate and control the functions of portable device 36 by using user interface 30.

There are multiple communication standards available for exporting display content from portable computing device 36 to interface 30. These standards range from high bandwidth direct connect interfaces such as DVI (Digital Video Interface), HDMI (High Definition Multimedia Interface), CI (Component Interface), etc. to lower bandwidth and streaming wireless standards such as IEEE 802.11. However, only a few portable devices currently offer direct access to these interfaces/standards.

According to the present invention, the portable device can announce its actual control interfaces to the remote device so that the remote device can more precisely emulate the actual control interfaces. In one embodiment, upon connection to this remoting interface (i.e., upon establishing communication between the remote peripheral device and the portable computing device), the remote device queries the capabilities of the portable device.

In a specific embodiment, in response to the query from the remote peripheral device, the portable device supplies a list of standard named control inputs supported by the portable device. These control inputs may come from a list of universally understood actions that can be remotely emulated. A partial list of such control inputs is provided below as an example:

VOL_UP
VOL_DOWN
PLAY
STOP
NEXT_TRACK
SKIP_FORWARD
SKIP_BACK
PHONE_PAD
ASCII_KEYBOARD
TOUCH_SCREEN
SOFT1-SOFT9

In one embodiment, portable device 36 can provide remote interface 30 with a bitmap image of a complete remote control interface including indicators for the location of appropriate control inputs. This format may be similar to an image map used in HTML. In this way, for example, an interface 30 with a touch screen can replicate and display the exact interactive remote control that is provided by the portable device.

When infotainment console 18 detects that a user has entered control inputs into interface 30, console 18 may then provide commands to portable device 36 indicating the desired action by device 36 that the user has requested via the control inputs.

In personal computer environments, may peripherals (e.g., mice, keyboards, joysticks, etc.) are already able to announce their capabilities to the host computer using a human interface device (HID) descriptor. The present invention reverses this process by enabling the controlled device (the host computer in this case) to tell the peripheral what kind of device it needs. The peripheral then emulates that device. This model is particularly useful when the peripheral (in this case an automobile or home theater system) is actually more complex than the computing device and therefore able to emulate many possible control devices.

In operation, the user initiates communication between infotainment console 18 and portable device 36. This may be accomplished by configuring wireless communication device 28 to generate a continuous wireless identification signal that may be recognized by portable device 36. Alternatively, user interface 30 may be equipped with a button that, when engaged, causes wireless communication device 28 to generate the identification signal. Accordingly, when the user is ready to connect to wireless communication device 28, the user may engage the button, thereby causing wireless communication device 28 to generate the signal. The user then causes portable device 36 to search for a wireless signal in the area. For instance, laptop computers typically have a network signal search button that the user engages to search for wireless networks, routers, hubs, modems or other wireless devices in the area. Portable device 36 recognizes the identification signal generated by wireless communication device 28, provides the user with the information identifying wireless communication device 28 and gives the user the option of connecting with wireless communication device 28. Portable device 36 may provide the option of connecting with wireless communication device 28 by providing a menu listing the available networks, modems and wireless signals in the area, including the wireless signal of wireless communication device 28, and allowing the user to select the wireless signal of the wireless communication device 28 using a touch pad, key pad, mouse or other user interface.

The above described connection method may be accomplished using radio frequency communications. However, it should be understood that communicative connection between console 18 and portable device 36 may be accomplished using other communication means including, for instance, a hard-wired connection. In addition, wireless communication device 28 need not be configured to continuously transmit an identification signal. Rather, console 18 can be configured such that user interface 30 includes a call button or transmit button that, upon engagement or actuation by the user, causes wireless communication device 28 to transmit a signal, such as an identification signal, recognizable by portable device 36. Alternatively, wireless communication device 28 may be configured to receive calls from portable device 36, such that portable device 36 can transmit a call signal recognizable and answered by wireless communication device 28.

Once portable device 36 is connected to console 18 via wireless communication device 28, application program interface 24 senses the connection and, in response thereto, initiates a download of the user interface configuration of portable device 36 to application program interface 24. More particularly, application program interface 24 queries portable device 36 for its capabilities and user interface configuration. This may be accomplished at the time portable device 36 is connected to console 18 via wireless communication device 28. In other words, once application program interface 24 recognizes that portable device 36 has connected, application program interface 24 may ask portable 36 for the layout and features of the user interface of portable device 36. Portable device 36 then responds with information pertaining to the details, options, layout and features of its user interface, and this response is transmitted to infotainment console 18 via wireless communication device 28.

Having received the user interface information from portable device 36, infotainment console 18 may use the information to mimic or replicate all the features and graphics of the portable device's user interface on user interface 30. Further, because of the better developed controls and graphics capability of user interface 30, features or graphics may be provided to the user on interface 30 that were not available on the portable device's user interface. Thus, in addition to providing bigger controls and a bigger display, user interface 30 may provide additional features and/or information.

Thus, once the user interface of portable device 36 is downloaded to infotainment console 18 in response to the queries from console 18, user interface 30 displays to the user a menu and platform in which the user may make selections, provide inputs, and control the functions relating to the operation of portable device 36. The user then controls the operation of portable device 36 using user interface 30, such as by actuation of the controls on interface 30.

Although user interface 30 may mimic the user interface of portable device 36, the rear seat display 26b may or may not also mimic the display of the portable device. It is possible within the scope of the invention for rear seat display 26b to be equipped with all of the input control necessary to fully replicate the user interface of portable device 36.

According to the present invention, infotainment console 18 may send specific queries to the portable device regarding the portable device's user interface configuration. The querying process may be an efficient way for infotainment console 18 to receive user interface configuration information that may be easily applied to and related to the specific user interface 30 that is to mimic the portable device's user interface and that is to provide enhancements thereto. For instance, infotainment console 18 may ask for pieces of information each of which are known to relate to only a certain corresponding input control or output of user interface 30. Thus, each of the components of user interface 30 may be programmed individually by use of the query responses that pertain to only that certain component.

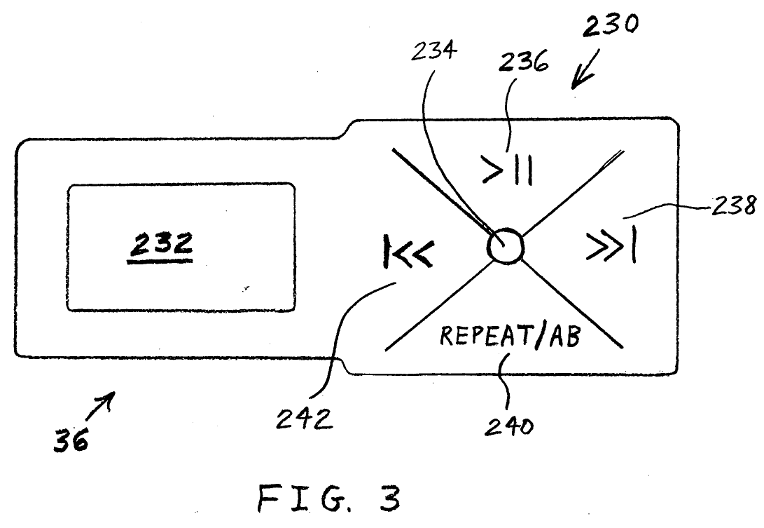

FIG. 3 illustrates one embodiment of a user interface 230 of a portable computing device 36 in the form of an mp3 player, including an LCD display screen 232 and pushbuttons 234, 236, 238, 240 and 242. Infotainment console 18 may interrogate portable computing device 36, as described above, and portable computing device 36 may respond to the queries with information describing the layout and function of user interface 230. Thus, portable computing device 36 may have stored in memory information related to the physical layout of pushbuttons 234, 236, 238, 240 and 242.

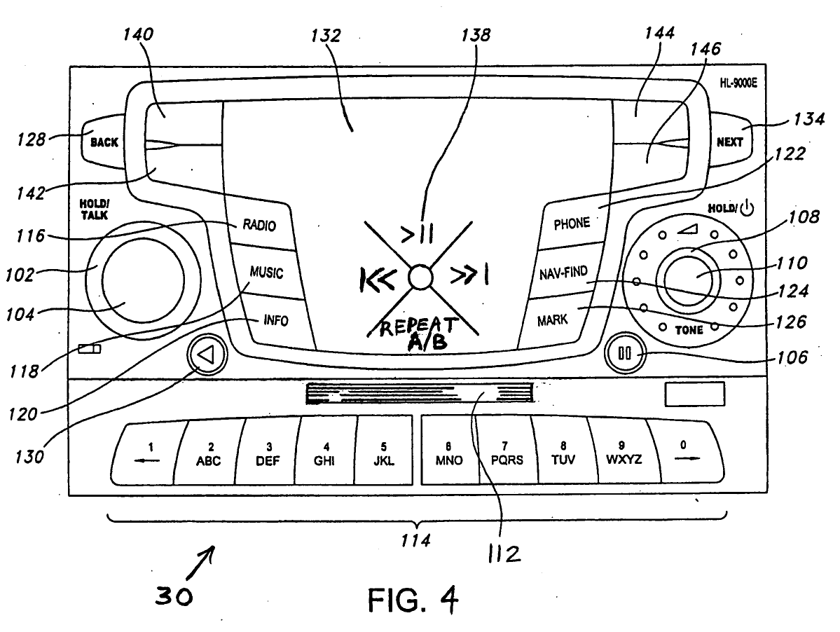

FIG. 4 illustrates one embodiment of user interface 30 after having received answers to the user interface configuration queries. First display area 132 is reconfigured to mimic display screen 232 of portable device 36, and second display area 138 is reconfigured to mimic pushbuttons 234, 236, 238, 240 and 242. That is, second display area 138 may be in the form of a touch screen display such that a user can select the mimicked pushbuttons 234, 236, 238, 240 and 242 by touching second display area 138 in the corresponding areas.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A control arrangement for a vehicle, comprising:
an infotainment console including a first user interface; and
a wireless communication device communicatively coupled to the infotainment console and adapted to relay wireless signals between the infotainment console and a portable computing device, wherein the infotainment console is configured to:
interrogate the portable computing device regarding a configuration of a second user interface belonging to the portable computing device;
receive responses to the interrogation from the portable computing device; and
reconfigure the first user interface to substantially replicate a layout and functions of the second user interface.

2. The arrangement of claim 1 wherein the first user interface includes a touch screen display, the infotainment console being configured to reconfigure the touch screen display to replicate at least one pushbutton of the second user interface.

3. The arrangement of claim 1 wherein said wireless communication device is a radio frequency communications module.

4. The arrangement of claim 1 wherein the responses include a list of control inputs supported by the portable computing device.

5. The arrangement of claim 1 wherein the interrogation includes at least one query regarding a physical layout of the second user interface.

6. The arrangement of claim 1 wherein the interrogation includes queries related to individual control inputs of the first user interface.

7. The arrangement of claim 1 wherein the first user interface includes audio speakers, the infotainment console being configured to receive audio signals from the portable computing device and relay the audio signals to the audio speakers.

8. A control method, comprising:
providing a peripheral device having a first user interface;
providing a portable computing device having a second user interface;
communicatively coupling the portable computing device to the peripheral device;
using the peripheral device to interrogate the portable computing device regarding a configuration of the second user interface;
using the peripheral device to receive responses to the interrogation from the portable computing device; and
reconfiguring the first user interface to substantially replicate a layout and functions of the second user interface.

9. The method of claim 8 wherein a wherein the first user interface includes a touch screen display, the infotainment console being configured to reconfigure the touch screen display to replicate at least one pushbutton of the second user interface.

10. The method of claim 8 comprising the further step of providing a radio frequency communications module for communicatively coupling the portable computing device to the peripheral device.

11. The method of claim 8 wherein the responses include a list of control inputs supported by the portable computing device.

12. The method of claim 8 wherein the interrogation includes at least one query regarding a physical layout of the second user interface.

13. The method of claim 8 wherein the interrogation includes queries related to individual control inputs of the first user interface.

14. The method of claim 8 comprising the further steps of:
using the infotainment console to receive audio signals from the portable computing device; and
relaying the audio signals to audio speakers.

15. A control arrangement, comprising:
an infotainment console including a first user interface having a touch screen display; and
a communication device communicatively coupled to the infotainment console and adapted to relay signals between the infotainment console and a portable computing device, wherein the infotainment console is configured to:
interrogate the portable computing device regarding a second user interface belonging to the portable computing device;
receive responses to the interrogation from the portable computing device; and
reconfigure the first user interface to substantially replicate a layout and functions of the second user interface, the reconfiguring including replicating pushbuttons of the second user interface on the touch screen display.

16. The arrangement of claim 15 wherein the communication device comprises a wireless communication device adapted to relay wireless signals between the infotainment console and the portable computing device.

17. The arrangement of claim 15 wherein the responses include a list of control inputs supported by the portable computing device.

18. The arrangement of claim 15 wherein the interrogation includes at least one query regarding a physical layout of the second user interface.

19. The arrangement of claim 15 wherein the interrogation includes queries related to individual control inputs of the first user interface.

20. The arrangement of claim 15 wherein the first user interface includes audio speakers, the infotainment console being configured to receive audio signals from the portable computing device and relay the audio signals to the audio speakers.
